(19) United States
(12) Patent Application Publication
(10) Pub. No.: US 2020/0068287 A1
(43) Pub. Date: Feb. 27, 2020

(54) EAR PLUGS WITH WIRELESS SOUND GENERATION AND CONTROL

(71) Applicant: Kyle Kennedy, Ammon, ID (US)

(72) Inventor: Kyle Kennedy, Ammon, ID (US)

(21) Appl. No.: 16/369,381

(22) Filed: Mar. 29, 2019

Related U.S. Application Data
(60) Provisional application No. 62/650,787, filed on Mar. 30, 2018.

(51) Int. Cl. H04R 1/10

(52) U.S. Cl. CPC H04R 1/1041; H04R 1/1025; H04R 2420/07; H04R 1/1083; H04R 1/1016

(57) ABSTRACT

A controllable audible ear plug system. The system may include an ear plug and a programmable handheld computing device. The ear plug may include a body portion, a wireless speaker, and a power source. A portion of the ear plug is insertable into an auditory canal of the wearer's ear to inhibit sound from outside the ear plug and the auditory canal from passing to an ear drum of the wearer's ear. The handheld computing device is operable to control the wireless speaker to generate sound that is audible to the wearer of the ear plug when the portion of the ear plug is inserted into the cavity of the wearer's ear.

### RELATED APPLICATION

This application claims the benefit of the filing date of U.S. Provisional Application No. 62/650,787, filed on 30 Mar. 2018, and entitled EAR PLUGS WITH WIRELESS SOUND GENERATION AND CONTROL, the disclosure of which is incorporated, in its entirety by this reference.

### TECHNICAL FIELD

The present disclosure relates generally to ear plugs, and more particularly to ear plugs with controllable sound generation capabilities.

### BACKGROUND

Ear plugs are commonly used to help block out sound so that a wearer can more easily sleep. Ear plugs are also used in work and recreation environments where potentially sounds are present that could potentially damage a wearer's hearing. When ear plugs are in use, however, the wearer often cannot hear sounds that they would otherwise want to hear, such as an alarm when the person is sleeping, verbal communications from those with whom the wearer is recreating, or announcements and/or emergency signals in a work environment.

In view of these and other shortcomings related to the use of ear plug, many people do not use ear plugs when they should, as they would have to deal with unwanted consequences if they do use ear plugs. Opportunities exist for improvements in ear plugs that can address these and other challenges.

### SUMMARY

One aspect of the present disclosure relates to an ear plug device that includes a body portion including a deformable sound absorbing material, a speaker positioned in or on the body portion, and a controller positioned in the body portion and operable to control the speaker.

The controller may be in wireless communication with a remote computing device to receive control signals from the remote computing device for operation of the speaker. The control signals may include at least one of a volume control signal, an on/off control signal, and an audio data file. The control signals may include a streaming audio signal. The body portion may include a cavity, and the speaker and controller may be positioned in the cavity. The ear plug device may also include a power source. The power source may include a rechargeable battery. The speaker and controller may be packaged together as a wireless speaker module. The wireless speaker module may be configured as a Bluetooth wireless speaker.

Another aspect of the present disclosure relates to a controllable audible ear plug system. The system may include an ear plug and a programmable handheld computing device. The ear plug may include a body portion, a wireless speaker, and a power source. A portion of the ear plug is insertable into an auditory canal of the wearer's ear to inhibit sound passing to an ear drum of the wearer's ear. The handheld computing device is operable to control the wireless speaker to generate sound that is audible to the wearer of the ear plug when the portion of the ear plug is inserted into the cavity of the wearer's ear.

The wireless speaker may be a Bluetooth speaker. The power source may be a rechargeable battery. The handheld computing device may include a speaker and be programmable to generate an audible alarm with the speaker concurrent with generating the sound with the wireless speaker. The body portion may include a compressible material that conforms to a shape of the auditory canal of the wearer's ear.

A further aspect of the present disclosure relates to a method of operating a sound generating ear plug. The method includes providing an ear plug comprising a body portion, a wireless speaker, and a power source, inserting a portion of the ear plug into an auditory canal of a wearer's ear, receiving a control signal to operate the speaker to generate sound, and generating sound with the wireless speaker, in response to the received control signal, the sound being audible to the wearer of the ear plug when the portion of the ear plug is inserted into the auditory canal of the wearer's ear.

The sound may be an alarm. The body portion may include a compressible, sound dampening material. The power sources may be a rechargeable battery, and the method further include powering the wireless speaker with the rechargeable battery. The wireless speaker may include an on/off switch, and the method may further include turning the wireless speaker on prior to receiving the control signal. The wireless speaker may have a low power sleep mode.

Additional advantages and novel features of the invention will be set forth in the description which follows or may be learned by those skilled in the art through reading these materials or practicing the examples disclosed herein.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is schematic perspective view of an ear plug control system in accordance with this disclosure;

FIG. 2 is a schematic exploded view of an ear plug shown in FIG. 1;

FIG. 3 is a flow diagram showing steps of an example method in accordance with this disclosure;

FIG. 4 is a flow diagram showing steps of another example method in accordance with this disclosure;

FIG. 5 shows a diagram of a system in accordance with various aspects of this disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure is directed to ear plugs having sound generating capabilities and related systems that implement such ear plugs to provide wearers with the ability to receive audible messages while wearing the ear plugs. In one example, the ear plugs include a speaker that is at least partially imbedded in or otherwise mounted to the sound dampening material of the ear plug. The speaker is positioned sufficiently close to the wearer's ear and configured to generate a type and volume of sound that is audible by the wearer while the sound dampening portion of the ear plug is inserted into the auditory canal of the wearer's ear.

The speaker may be controlled remotely, such as by computing device located remote from the ear plugs (e.g., a mobile computing device such as a smart phone, laptop computer, tablet, smart watch, personal digital assistant, or the like, or a stationary computing device such as a desktop computer, computer network, home or building security system, public announcement system, or the like). In other embodiments, the ear plugs may comprise a controller, circuitry and power source that is independently programmable and operable to control the speaker as desired. In still other embodiments, multiple ear plugs being used by the same wearer, or ear plugs being worn by different wearers, may be controlled by a single computing device. The ear plugs may be networked together and/or may be controlled simultaneously to receive control signals, information, data, and the like.

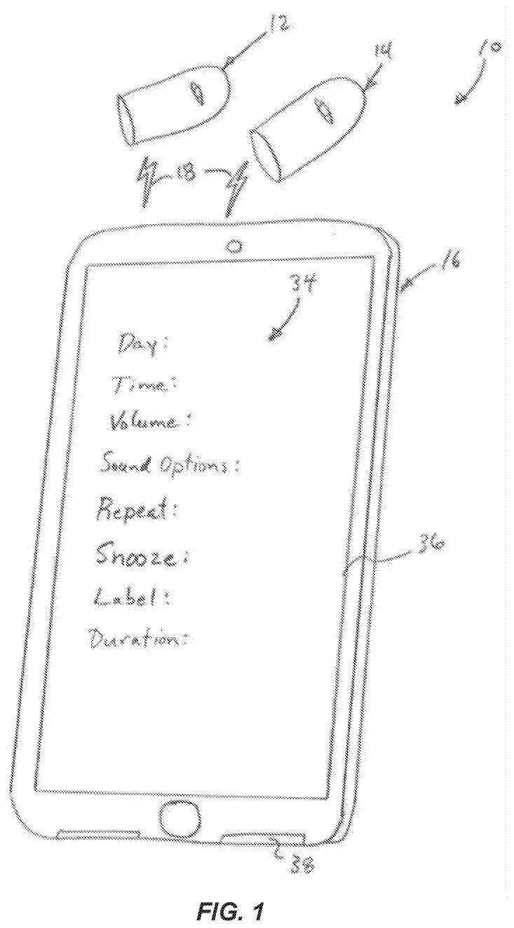

Referring now to FIG. 1, an example ear plug system 10 is shown and described. The ear plug system 10 includes first and second ear plugs 12, 14 and a computing device 16. The computing device 16 may communicate with the ear plugs 12, 14 wirelessly via wireless signals 18. In other embodiments, the computing device 16 may be connected to the ear plugs 12, 14 with a wired connection. In still further embodiments, the computing device 16 may communicate with the ear plugs 12, 14 through an intermediary device such as a device carried by the wearer (e.g., on an exterior of the wearer's ear or on the wearer's clothing) or on the ear plugs 12, 14 themselves.

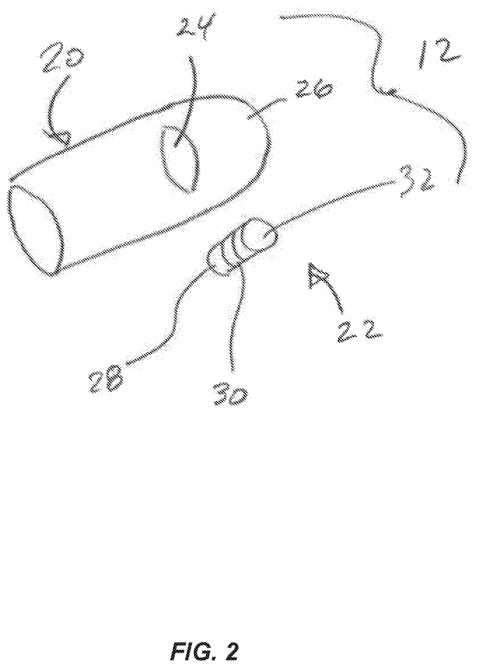

FIG. 2 shows the ear plug 12 having a body portion 20 and a speaker module 22. The body portion 20 may include a cavity 24 sized to receive the speaker module 22. The cavity 24 may pass completely through the body portion 20, or may pass only partially through the body portion 20. The cavity 24 may have any desired shape or size. The body portion 20 may also include an insertion end 26 that is sized and configured to be inserted into an auditory canal of a wearer's ear. The body portion 20 may comprise a compressible material that is at least partially compressible to more easily fit into the auditory canal and is then self-expanding to closely match the internal shape of the auditory canal to create a close, interference fit connection with the wearer's ear. The material of the body portion 20 may also have high sound absorption properties to help limit the amount of sound that passes through the auditory canal to the ear drum and inner ear of the wearer. Some example materials for body portion 20 include polyvinyl chloride (PVC) or polyurethane (PU) (memory foam).

The speaker module 22 is sized to fit into the cavity 24. The speaker module 22 is shown as an assembly module having multiple components of a speaker 28, a controller 30, and a power source 32. In other embodiments, at least the speaker 28 and controller 30 are assembled as a unitary module and the power source 32 is provided as a separate part. In one example, the power source 32 may include a rechargeable battery. The power source 32 may be charged using wireless or wired technologies. In some embodiments, the power source 32 may be charged by the signal 18 received from the computing device 16. The speaker 28, controller 30 and power source 32 together may be provided as, for example, a Bluetooth controlled speaker module, while other wireless communications technologies are possible as described below.

The computing device 16 may provide various options for controlling the sound generated by speaker module 22. FIG. 1 shows some example options 34 related to the sound being generated in the form of an alarm to help wake up the wearer when sleeping with the ear plugs 12, 14 inserted in the wearer's ears. The options 34 include day, time, volume level, type of sound, repeat, snooze, label, and duration. The options 34 may be visible on a display screen 36 of the computing device 16. The computing device 16 may itself include one or more speakers 38 that generate sound based on the options 34 concurrently or independently of the sounds generated by speaker module 22 of the ear plugs 12, 14.

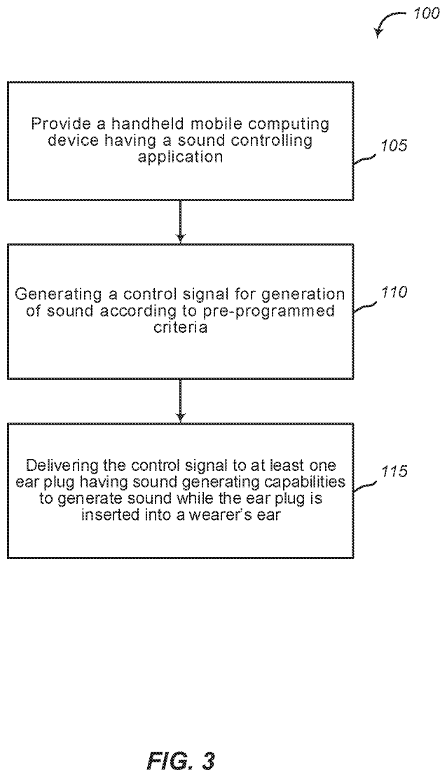

Referring now to FIG. 3, an example method 100 associated with controlling an ear plug with sound generating capabilities is shown. The method 100 may include, at block 105, the step of providing a handheld mobile computing device having a sound controlling application. At block 110, the method 100 includes generating a control signal for generation of sound according to pre-programmed criteria. At block 115, the method includes delivering the control signal to at least one ear plug having sound generating capabilities to generate sound while the ear plug is inserted into a wearer's ear. The handheld mobile computing device may be a smart phone. The pre-programmed criteria may include at least one of a day, time, volume level, type of sound, repeat, snooze, label, and duration associated with an alarm.

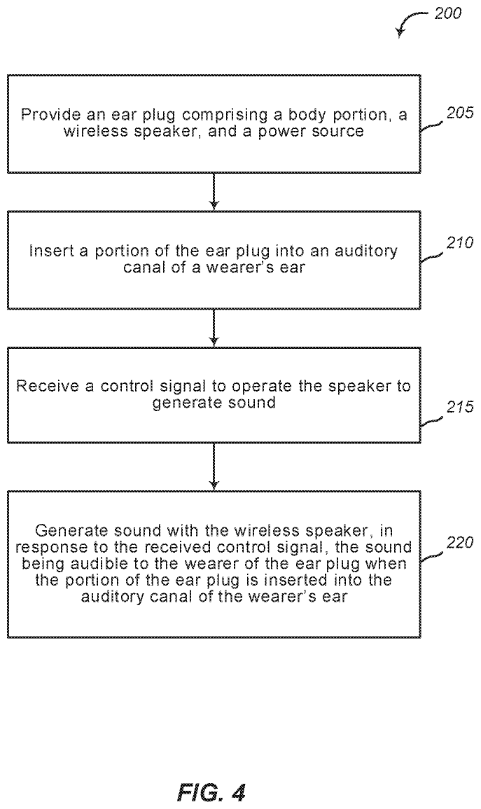

FIG. 4 illustrates a method 200 of operating a sound generating ear plug. The method 200 may include, at block 205, providing an ear plug comprising a body portion, a wireless speaker, and a power source. Block 210 includes inserting a portion of the ear plug into an auditory canal of a wearer's ear. Block 315 includes receiving a control signal to operate the speaker to generate sound. The method 200 also includes generating sound with the wireless speaker, in response to the received control signal, the sound being audible to the wearer of the ear plug when the portion of the ear plug is inserted into the auditory canal of the wearer's ear.

The various methods 100, 200 and their associated steps may be modified or altered in accordance with the present disclosure to include more or fewer steps than those illustrated in the figures. Accordingly, the flow diagram shown in FIGS. 3-4 should not exclude any step or variation of methods, features and/or functionality described herein.

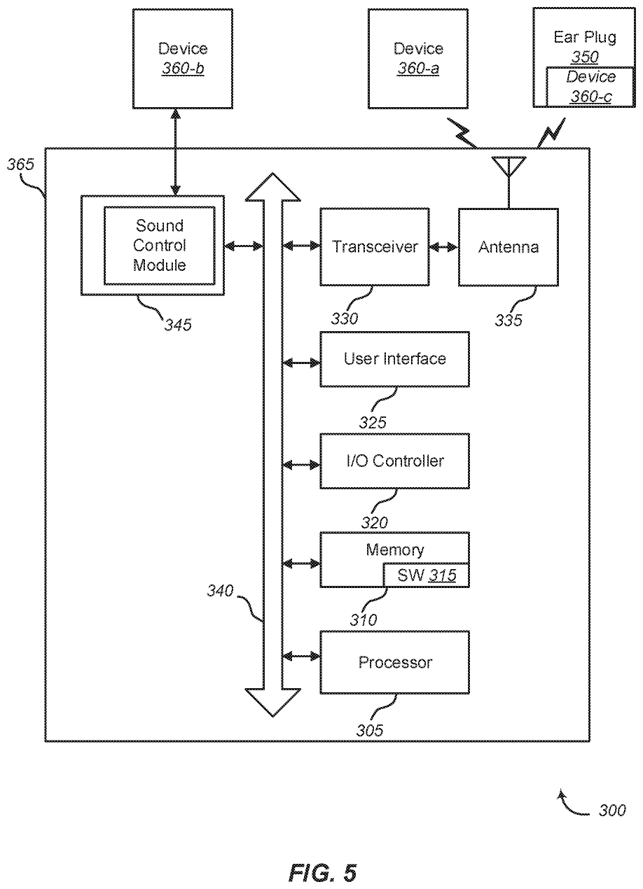

FIG. 5 shows a system 300 for use with the ear plugs 12, 14 and ear plug systems 10 shown in FIGS. 1-2. System 300 may include a control panel 365. Control panel 365 may be equivalent at least in part to a controller, control unit, processor or the like for use with the devices described above with reference to FIGS. 1-2. Control panel 365 may include sound control module 345. The sound control module 345 may provide communications with one or more devices 360 (also referred to as speakers or ear plugs) directly or via other communication components, such as a transceiver 330 and/or antenna 335. The device 360 may represent one or more of the ear plugs 12, 14, or pairs of such ear plugs 12, 14, or any subcomponent thereof, in any of the embodiments described above. The sound control module 345 may perform or control various operations associated with, for example, the ear plugs 12, 14, speaker modules 22, controllers 30, or other components of the devices and related systems described above with reference to FIGS. 1-2 and the related methods in FIGS. 3-4.

Control panel 365 may also include a processor module 305, and memory 310 (including software/firmware code (SW) 315), an input/output controller module 320, a user interface module 325, a transceiver module 330, and one or more antennas 335 each of which may communicate, directly or indirectly, with one another (e.g., via one or more buses 340). The transceiver module 330 may communicate bi-directionally, via the one or more antennas 335, wired links, and/or wireless links, with one or more networks or remote devices. For example, the transceiver module 330 may communicate bi-directionally with one or more of ear plug 350 and/or devices 360-a, 360-c. The ear plug 350 may be components of the ear plug devices and related systems described with reference to FIGS. 1-2, or other devices in communication with such systems and devices. The transceiver 330 may include a modem to modulate the packets and provide the modulated packets to the one or more antennas 335 for transmission, and to demodulate packets received from the one or more antennas 335. In some embodiments (not shown) the transceiver may communicate bi-directionally with one or more of ear plugs 350, remote control device 355, and/or devices 360-a, 360-c through a hardwired connection without necessarily using antenna 335. While a control panel or a control device (e.g., 305) may include a single antenna 335, the control panel or the control device may also have multiple antennas 335 capable of concurrently transmitting or receiving multiple wired and/or wireless transmissions. In some embodiments, one element of control panel 365 (e.g., one or more antennas 335, transceiver module 330, etc.) may provide a connection using wireless techniques, including digital cellular telephone connection, Cellular Digital Packet Data (CDPD) connection, digital satellite data connection, and/or another connection.

The signals associated with system 300 may include wireless communication signals such as radio frequency, electromagnetics, local area network (LAN), wide area network (WAN), virtual private network (VPN), wireless network (using 302.11, for example), 345 MHz, Z-WAVE®, cellular network (using 3G and/or LTE, for example), and/or other signals. The one or more antennas 335 and/or transceiver module 330 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 335 may receive signals or information specific and/or exclusive to itself. In other embodiments, each antenna 335 may receive signals or information not specific or exclusive to itself.

In some embodiments, one or more devices 360 may include sensors (e.g., voltage, inductance, resistance, current, force, temperature, etc.) or ear plugs 350 may connect to some element of system 300 via a network using one or more wired and/or wireless connections. In some embodiments, the user interface module 325 may include an audio device, such as an external speaker system, an external display device such as a display screen, and/or an input device (e.g., remote control device interfaced with the user interface module 325 directly and/or through I/O controller module 320).

One or more buses 340 may allow data communication between one or more elements of control panel 365 (e.g., processor module 305, memory 310, I/O controller module 320, user interface module 325, etc.).

The memory 310 may include random access memory (RAM), read only memory (ROM), flash RAM, and/or other types. The memory 310 may store computer-readable, computer-executable software/firmware code 315 including instructions that, when executed, cause the processor module 305 to perform various functions described in this disclosure (e.g., initiating an adjustment of a lighting system, etc.). Alternatively, the software/firmware code 315 may not be directly executable by the processor module 305 but may cause a computer (e.g., when compiled and executed) to perform functions described herein. Alternatively, the computer-readable, computer-executable software/firmware code 315 may not be directly executable by the processor module 305 but may be configured to cause a computer (e.g., when compiled and executed) to perform functions described herein. The processor module 305 may include an intelligent hardware device (e.g., a central processing unit (CPU), a microcontroller, an application-specific integrated circuit (ASIC), etc.).

In some embodiments, the memory 310 can contain, among other things, the Basic Input-Output system (BIOS) which may control basic hardware and/or software operation such as the interaction with peripheral components or devices. For example, the sound control module 345, and other modules and operational components of the control panel 365 used to implement the present systems and methods may be stored within the system memory 310. Applications resident with system 300 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 330, one or more antennas 335, etc.).

Many other devices and/or subsystems may be connected to one or may be included as one or more elements of system 300. In some embodiments, all of the elements shown in FIG. 5 need not be present to practice the present systems and methods. The devices and subsystems can be interconnected in different ways from that shown in FIG. 5. In some embodiments, an aspect of some operation of a system, such as that shown in FIG. 5, may be readily known in the art and are not discussed in detail in this application. Code to implement the present disclosure can be stored in a non-transitory computer-readable medium such as one or more of system memory 310 or other memory. The operating system provided on I/O controller module 320 may be iOS®, ANDROID®, MS-DOS®, MS-WINDOWS®, OS/2®, UNIX®, LINUX®, or another known operating system.

The transceiver module 330 may include a modem configured to modulate the packets and provide the modulated packets to the antennas 335 for transmission and/or to demodulate packets received from the antennas 335. While the control panel or control device (e.g., 305) may include a single antenna 335, the control panel or control device (e.g., 305) may have multiple antennas 335 capable of concurrently transmitting and/or receiving multiple wireless transmissions.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. An ear plug device, comprising:
a body portion comprising a deformable sound absorbing material;
a speaker positioned in or on the body portion;
a controller positioned in the body portion and operable to control the speaker.

2. The ear plug device of claim 1, wherein the controller is in wireless communication with a remote computing device to receive control signals from the remote computing device for operation of the speaker.

3. The ear plug device of claim 2, wherein the control signals include at least one of a volume control signal, an on/off control signal, and an audio data file.

4. The ear plug device of claim 2, wherein the control signals include a streaming audio signal.

5. The ear plug device of claim 1, wherein the body portion includes a cavity, and the speaker and controller are positioned in the cavity.

6. The ear plug device of claim 1, further comprising a power source.

7. The ear plug device of claim 6, wherein the power source is a rechargeable battery.

8. The ear plug device of claim 1, wherein the speaker and controller are packaged together as a wireless speaker module.

9. The ear plug device of claim 8, wherein the wireless speaker module is configured as a Bluetooth wireless speaker.

10. A controllable audible ear plug system, comprising:
an ear plug comprising a body portion, a wireless speaker, and a power source, a portion of the ear plug being insertable into an auditory canal of the wearer's ear to inhibit sound passing to an ear drum of the wearer's ear;
a programmable handheld computing device operable to control the wireless speaker to generate sound that is audible to the wearer of the ear plug when the portion of the ear plug is inserted into the auditory canal of the wearer's ear.

11. The system of claim 10, wherein the wireless speaker is a Bluetooth speaker.

12. The system of claim 10, wherein the power source is a rechargeable battery.

13. The system of claim 10, wherein the handheld computing device includes a speaker and is programmable to generate an audible alarm with the speaker concurrent with generating the sound with the wireless speaker.

14. The system of claim 10, wherein the body portion comprises a compressible material that conforms to a shape of the auditory canal of the wearer's ear.

15. A method of operating a sound generating ear plug, comprising:
providing an ear plug comprising a body portion, a wireless speaker, and a power source;
inserting a portion of the ear plug into an auditory canal of a wearer's ear;
receiving a control signal to operate the speaker to generate sound; and
generating sound with the wireless speaker, in response to the received control signal, the sound being audible to the wearer of the ear plug when the portion of the ear plug is inserted into the auditory canal of the wearer's ear.

16. The method of claim 15, wherein the sound is an alarm.

17. The method of claim 15, wherein the body portion comprises a compressible, sound dampening material.

18. The method of claim 15, wherein the power sources is a rechargeable battery, the method further comprising powering the wireless speaker with the rechargeable battery.

19. The method of claim 15, wherein the wireless speaker includes an on/off switch, the method further comprising turning the wireless speaker on prior to receiving the control signal.

20. The method of claim 15, wherein the wireless speaker has a low power sleep mode.
